(19) United States
(12) Patent Application Publication
(10) Pub. No.: US 2015/0266096 A1
(43) Pub. Date: Sep. 24, 2015

(54) SILVER NANOWIRES WITH THIN DIAMETER AND HIGH ASPECT RATIO AND HYDROTHERMAL SYNTHESIS METHOD FOR MAKING THE SAME

(71) Applicant: Blue Nano Inc., Charlotte, NC (US)

(72) Inventors: Chaohao HOU, Jinang (CN); Shangling TIAN, Jinan (CN); Brandon TRAVIS, Charlotte, NC (US)

(73) Assignee: Blue Nano Inc., Charlotte, NC (US)

(21) Appl. No.: 14/218,099

(22) Filed: Mar. 18, 2014

(51) Int. Cl. B22F 9/24; H01B 1/02; B22F 1/00

(52) U.S. Cl. CPC B22F 9/24; B22F 1/004; B22F 1/0044; H01B 1/02; B22F 2009/245; B22F 2301/255; B22F 2304/05

(57) ABSTRACT

A method for producing silver nanowires comprising the steps of: dissolving a silver reducing agent, an organic polymer template protective compound and a halogen ion solution in highly pure water resulting in solution A; dissolving a silver ionic species in highly pure water resulting in solution B; mixing solution A and solution B together resulting in solution C; incubating solution C for a period of time; heating solution C for a period of time; cooling solution C to room temperature; collecting the silver nanowires.

### FIELD OF THE INVENTION

This invention relates to the field of nanotechnology, and more particularly the invention relates to a hydrothermal synthesis method for making thin silver nanowires with high aspect ratios and compositions thereof.

### BACKGROUND OF THE INVENTION

Thin silver nanowires have unique magnetic, electrical, optical, and thermal properties. Because of this, silver nanowires have recently received a considerable amount of research attention. They have been used in many applications, such as transparent electrodes (US 20110024159A1), (Adv. Mater., 2011, 23, 4453-4457), thermally conductive silicone grease and other electronic devices (US 20090269604A1). The transparent electrode using silver nanowires is a particularly good alternative to ITO (Indium-Tin-Oxide)-based electrodes because of its high performance and low cost, thus, demand for thin silver nanowires with high aspect ratios is increasing.

Preparation methods used to make silver nanowires affect their physical and chemical properties and the performance of devices where such nanowires are used for selected applications. For this reason it is very important to develop well-controlled and reproducible synthesis processes. Recently, both physical and chemical methods have been used to synthesize silver nanowires. The chemical methods were developed rapidly because of the simple equipment requirements and advantages of scaling-up of this process. Among these, the polyol process is an especially effective route to synthesize silver nanowires. It uses polyol (glycol, propylene glycol, propanetriol) as both a solvent and reducing agent, silver nitrate as a silver source, and poly-vinyl-pyrrolidone (PVP), or another similar polymers or surfactants, as a protecting agent and promoter of nanowire growth. However, the polyol process is very sensitive to impurities in raw materials, and can cause environmental contamination (Nature Protocols 2, 2182-2190 (2007). Because of these problems, the hydrothermal synthesis method of making silver nanowires has attracted significant research efforts (Chemistry Letters Vol. 33 (2004) No 9, p 1160-1161 & Adv. Mater. 2005, 17, 2626-2630). However, process repeatability using the hydrothermal method has not been good, and silver nanowires produced by it have not been able to satisfy specifications for commercial transparent conductive product applications. Therefore, developing an effective hydrothermal preparation method for making thin, high aspect ratio silver nanowires has great potential commercial value.

### SUMMARY OF THE INVENTION

A method for producing silver nanowires comprising the steps of: dissolving a silver reducing agent, an organic polymer template protective compound and a halogen ion solution in highly pure water resulting in solution A; dissolving a silver ionic species in highly pure water resulting in solution B; mixing solution A and solution B together resulting in solution C; incubating solution C for a period of time; heating solution C for a period of time; cooling solution C to room temperature; collecting the silver nanowires.

### BRIEF DESCRIPTION OF THE DRAWINGS/FIGURES

FIG. 1 is an SEM image of nanowires made according to the methods described within this application.

FIG. 2 is an SEM image of nanowires made according to the methods described within this application.

FIG. 3 is an SEM image of nanowires made according to the methods described within this application.

FIG. 4 is an SEM image of nanowires made according to the methods described within this application.

FIG. 5 is an SEM image of nanowires made according to the methods described within this application.

FIG. 6 is an SEM image of nanowires made according to the methods described within this application.

### DETAILED DESCRIPTION OF THE INVENTION

In view of the disadvantages of synthesizing silver nanowires using the polyol method, this invention discloses a novel hydrothermal synthesis method to produce silver nanowires.

The instant invention discloses silver nanowires with a thin diameter and a high aspect ratio and the hydrothermal synthesis method for making the same. The synthesis method for producing silver nanowires in this invention uses high purity water instead of polyol solvent, alleviating many serious problems of the polyol process and of other hydrothermal synthesis methods known by those having skill in the art. The process of the instant invention is simple, has high yield and low cost, can produce high quality silver nanowires with exceptionally thin diameter and high aspect ratio, and can be scaled-up to mass production. In addition, it meets the specifications required for transparent electrode applications, which are highly desirable and very important in commercial applications.

This invention provides a simple hydrothermal synthesis method to repeatedly produce high quality silver nanowires with very thin diameter and high aspect ratio by the following steps:
(a) adding a silver reducing agent, an organic polymer template protective compound and a halogen ion solution to highly pure water to obtain solution A;
(b) adding a solution containing a silver ionic species and highly pure water to said solution A to obtain solution B;
(c) incubating and heating solution B for a period of time suitable for the formation of silver nanowires.
   After cooling, the silver nanowires are collected.

In one embodiment of the above method, the organic polymer template protective compound is one that favors the formation of wires as opposed to other geometries. In another embodiment of the above method, the method includes an additional step of adding a prefabricated seed. The prefabricated seed is selected from the group including, but not limited to, silver chloride, silver bromide, silver iodide, or a combination thereof.

In another embodiment of the above method, the method further includes the steps of adding a prefabricated seed, mixing the silver reducing agent and the organic polymer template protective compounds and adding a silver ionic species resulting in a solution C. Solution C is then incubated for a period of time and/or heated in a pressurized reactor vessel for a period of time suitable for the formation of silver nanowires.

The instant invention also discloses a method for producing silver nanowires comprising the steps of
(a) dissolving a silver reducing agent, an organic polymer template protective compound and a halogen ion solution in highly pure water resulting in solution A;
(b) dissolving a silver ionic species in highly pure water resulting in solution B;
(c) mixing solution A and solution B together resulting in solution C;
(d) incubating solution C for a period of time;
(e) heating solution C for a period of time;
(f) allow solution C to cool down to room temperature; and
(g) collecting the silver nanowires.

In one embodiment of the above method, the organic polymer template protective compound is one that favors the formation of wires as opposed to other geometries. In another embodiment of the above method, the method includes an additional step of adding a prefabricated seed. The prefabricated seed is selected from the group including, but not limited to, silver chloride, silver bromide, silver iodide, or a combination thereof.

In another embodiment of the above method, the method further includes the steps of adding a prefabricated seed, mixing the silver reducing agent and the organic polymer template protective compounds and adding a silver ionic species resulting in a solution D. Solution D is then heated in a pressurized reactor vessel for a period of time suitable for the formation of silver nanowires.

In some embodiments of the above method, an insoluble prefabricated silver halide seed may be added to solution A above. The silver ionic species is material that will eventually be reduced into silver nanowires upon completion of the reduction reaction. The presence of the prefabricated silver halide seed can allow an increase in product yield.

While stirring solution A, solution B is added to solution A over a time period between 15 seconds and 10 minutes resulting in solution C. Solution B is added slowly to solution A to minimize local concentration gradients of chemical species and allow the formation of a more uniform product.

Following creation of solution C, solution C is stirred and allowed to incubate for a time between 30 minutes and 24 hours. Incubation allows the formation of seeds. The most thermodynamically stable shape of seed is that which, when grown, will result in formation of a nanowire crystal. However, this is not necessarily the first shape of the seed that is grown, so it is necessary to either allow or assist the seed in reaching thermodynamic equilibrium prior to initiating wire growth. This incubation step, along with the addition of halogen compounds or silver halogen salts, results in an increase in product yield. In one embodiment of the present invention, the above method results in a product yield in the range of 5 to 35%. In another embodiment, the above method results in a product yield in the range of 5 to 30%. In yet another embodiment, the above method results in a product yield in the range of 5 to 25%. In still another embodiment, the above method results in a product yield in the range of 5 to 20%. In yet another embodiment, the above method results in a product yield in the range of 5 to 15%.

Following incubation, the solution in any the above embodiments is heated to a temperature in the range of 100-200° C. It is believed that the heat speeds the reduction reaction, initiating growth of the wire from seeds already present in the solution. The incubation time for any of the above embodiments is in the range of 1 hour to 48 hours. Solutions are cooled to room temperature to allow for simpler collection of the product.

Regarding the methods described above
The silver reducing agent is selected from a group which includes, but is not limited to: polyethylene glycol (PG), glucose, citrate or a combination thereof.
   The purpose of the silver reducing agent is to convert the soluble silver ions that will eventually be added to the solution to an insoluble, neutral form that will crystallize. The reducing agent should be mild, slowly initiating this reduction reaction so that crystal growth can be controlled.
   The silver reducing agent has a molar ratio in the range of 3:1:1 and 200:100:1.
The organic polymer template protective compound is selected from the group which includes, but is not limited to, polyacrylonitrile (PAN), polyethylene glycol (PEG), polyoxyethylene (PEO), polyvinyl alcohol (PVA), polyvinylpyrrolidone (PVP), N-methyl pyrrolidone, vinyl pyrrolidone, 2-pyrrolidon, or a combination thereof.
   The purpose of the organic polymer template is to direct growth of silver crystals in preferred directions, allowing control of the silver nanowire shape that will eventually form.
   The organic polymer template protective compound has a molar ratio in the range of 3:1:1 and 200:100:1.
The halogen ion solution is selected from the group which includes, but is not limited to, sodium chloride, potassium chloride, sodium bromide, potassium bromide, sodium iodide, potassium iodide, tetrabutyl ammonium chloride, tetrabutylammonium bromide, hexadecyl trimethyl ammonium chloride, hexadecyl trimethyl ammonium bromide.
   The purpose of the halogen ion solution is to assist in the formulation of seeds and upon which reduced silver can deposit. This seeding increases product yield, the ratio of the weight of purified silver nanowires to the weight of silver ions used in the reaction. Halogen ions combine with silver ions in solution to form insoluble salts, which can act as a seeds for the growth of silver nanocrystals. Without these seeds, crystal growth proceeds more slowly, and product yields are much smaller.
   The concentration of the halogen ion solution is 0.001M-0.65 M.
   The halogen ion solution includes water selected from the group including, but not limited to, high-purity water, pure water, distilled water, ultrapure water.
The silver ionic species is selected from the group which includes, but is not limited to, silver nitrate, silver acetate, silver sulfate, and silver complex ion salts.
   The concentration of the silver ionic species is in the range of 0.001 M and 12.7 M.
   The silver ionic species has a molar ratio in the range of 3:1:1 and 200:100:1.
The highly pure water is selected from the group which includes, but is not limited to: low conductivity water, degassed water, distilled water, ultrapure water or a combination thereof.
   The highly pure water is defined as water with a resistivity >1 MΩ and total dissolved solids (TDS)<10.

### EXAMPLES

### Example 1

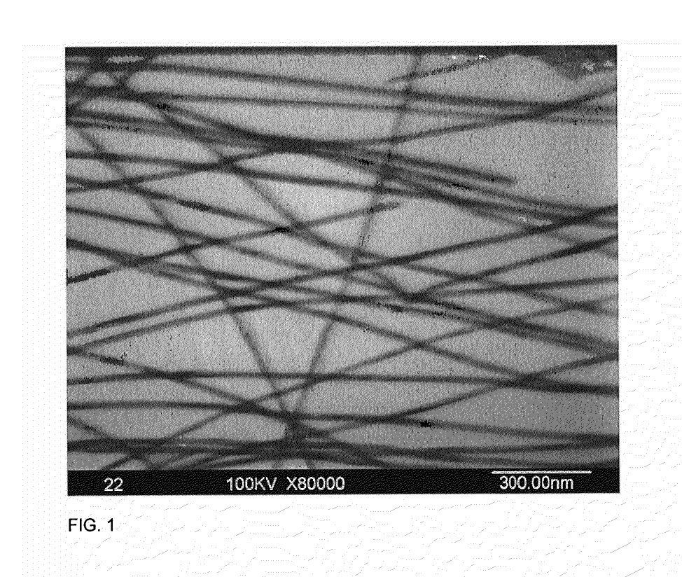

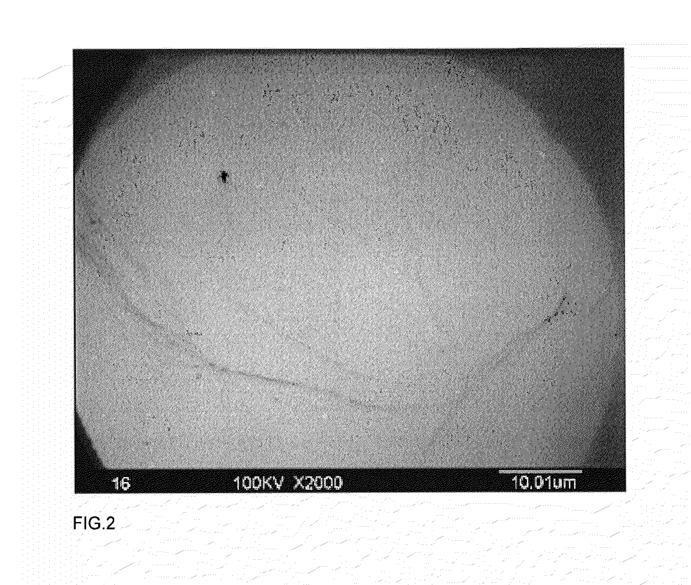

16 g PVP and 16 g glucose were added to 1120 ml high purity water and stirred, resulting in dessolution. 32 ml 0.04M tert-butyl ammonium chloride TBACl was then added to make solution A. 0.272 g AgNO₃ was added to 16 ml high purity water and stirred to make solution B. Solution A was stirred, and solution B was slowly added over a 2 minute time period to obtain solution C. Solution C was stirred at room temperature for 6.5 hours, then transferred into a Teflon-sealed autoclave and heated at 180° C. for 5.5 hours. Following this step, solution C was cooled to room temperature. Silver nanowires resulting from this process had a diameter of 24 nm and a length of 30 μm, as measured by scanning electron microscopy (SEM) and shown in FIGS. 1 and 2.

### Example 2

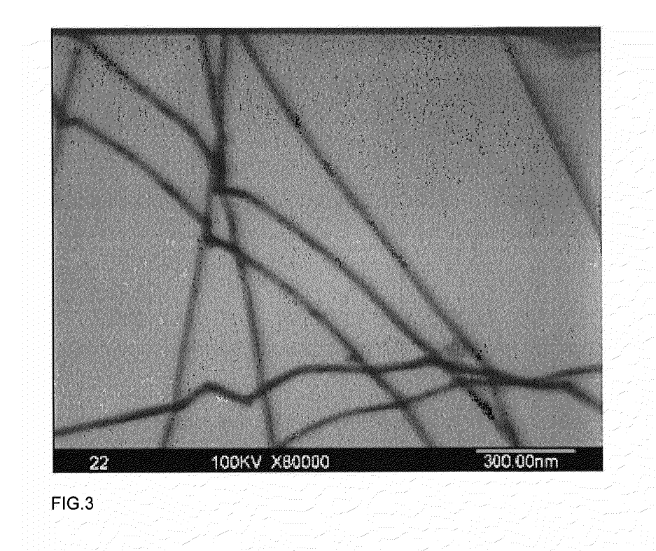

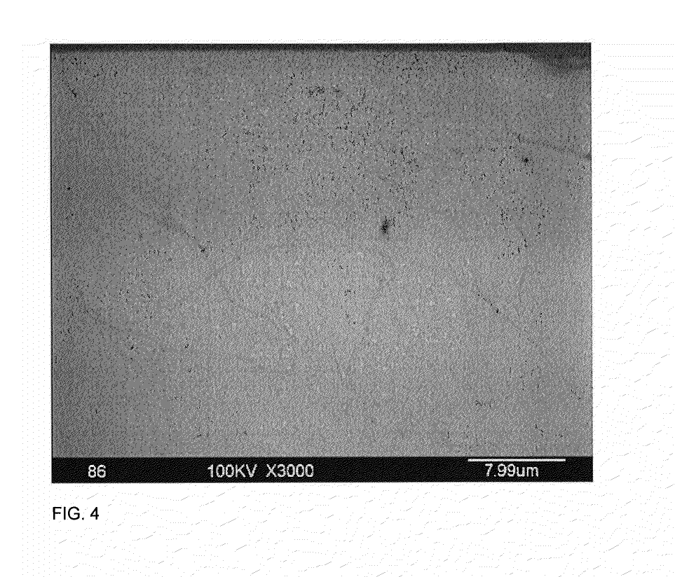

1.6 g PVP and 6.4 g glucose were added to 1120 ml high purity water and stirred, resulting in dessolution. 1.6 ml 0.04M TBACl was then added to make solution A. 0.544 g AgNO₃ was added to 32 ml high purity water and stirred to make solution B. Solution A was stirred, and solution B was slowly added to solution A over a 2 minute time period to obtain solution C. Solution C was stirred at room temperature for 4 hours, then transferred into a Teflon-sealed autoclave and heated at 180° C. for 6 hours. Following this step, solution C was cooled to room temperature. Silver nanowires resulting from this process had a diameter of 21 nm and a length of 18 μm, as shown in FIGS. 3 and 4.

### Example 3

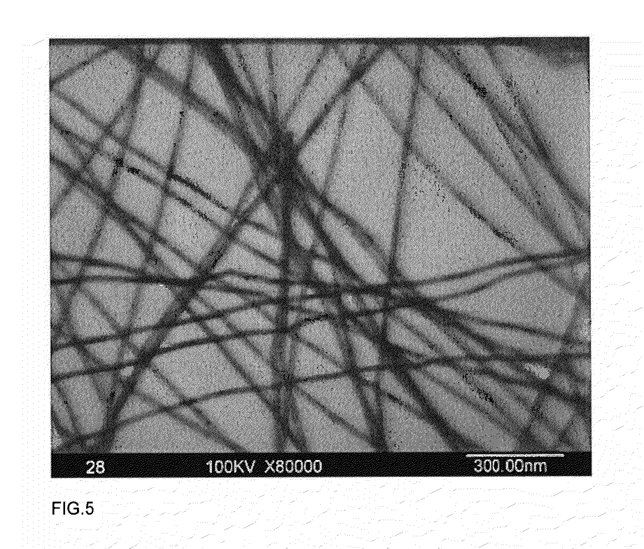

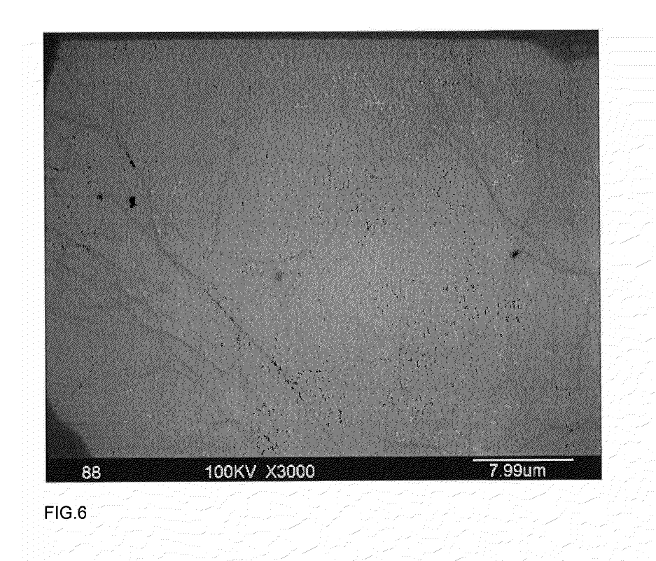

4 g PVP and 4 g glucose were added to 280 ml high purity water and stirred, resulting in dessolution. 40 ml 0.04 M TBACl was then added to make solution A. 0.34 g AgNO₃ was added to 20 ml high purity water and stirred to make solution B. Solution A was stirred, and solution B was slowly added to solution A over a 2 minute time period to obtain solution C. Solution C was stirred at room temperature for 5 hours, then was transferred into a Teflon-sealed autoclave and heated at 180° C. for 4.5 hours. Following this step, solution C was cooled to room temperature. Silver nanowires resulting from this process had a diameter of 23 nm and a length of 20 μm, as shown in FIGS. 5 and 6.

### Example 4

1 g PVP and 0.3 g polyethylent glucol (PG) were added to 140 ml high purity water and stirred, resulting in dessolution. 8 ml 0.04 M TBACl was then added to make solution A. 0.068 g AgNO₃ added to in 4 ml high purity water and stirred to make solution B. 0.5 ml of solution B, Solution A was stirred, and solution B was slowly added over a 2 minute time period to obtain solution C. Solution C was stirred at room temperature for 4 hours, then transferred into a Teflon-sealed autoclave and heated at 180° C. for 3.5 hours. Following this step, solution C was cooled to room temperature. Silver nanowires resulting from this process had a diameter of 25 nm and a length of 15 μm.

The present invention may be embodied in other forms without departing from the spirit and the essential attributes thereof, and, accordingly, reference should be made to the appended claims, rather than to the foregoing specification, as indicating the scope of the invention. The invention illustratively discloses herein suitably may be practiced in the absence of any element which is not specifically disclosed herein.

1. A method for producing silver nanowires comprising the steps of:
dissolving a silver reducing agent, an organic polymer template protective compound and a halogen ion solution in highly pure water resulting in solution A;
dissolving a silver ionic species in highly pure water resulting in solution B;
mixing solution A and solution B together resulting in solution C;
incubating solution C for a period of time;
heating solution C for a period of time;
allow solution C to cool down to room temperature;
collecting the silver nanowires.

2. The method of claim 1, wherein the water is selected from the group which includes, but is not limited to: low conductivity water, degassed water, distilled water, ultrapure water or a combination thereof.

3. The method in claim 1, wherein the silver reducing agent is selected from the group which includes, but is not limited to: polyethylene glycol (PG), glucose, citrate or a combination thereof.

4. The method in claim 1, further including an organic polymer template protective compound that favors the formation of wires as opposed to other geometries.

5. The method in claim 4, wherein the organic polymer template protective compound includes, but is not limited to, polyacrylonitrile (PAN), polyethylene glycol (PEG), polyoxyethylene (PEO), polyvinyl alcohol (PVA), polyvinylpyrrolidone (PVP), N-methyl pyrrolidone, vinyl pyrrolidone, 2-pyrrolidon, or a combination thereof.

6. The method of claim 1, wherein said method further includes the step of adding a prefabricated seed.

7. The method of claim 6, wherein the prefabricated seed is a silver halide particle selected from the group which includes, but is not limited to silver chloride, silver bromide, silver iodide.

8. The method of claim 1, where said method further includes the steps of:
adding a prefabricated seed;
mixing said silver reducing agent and said organic polymer template protective compounds; and adding a silver ionic species resulting in a solution D;
heating said solution D in a pressurized reactor vessel for a period of time suitable for the formation of silver nanowires.

9. The method of claim 1, wherein the silver ionic species is selected from the group which includes, but is not limited to, silver nitrate, silver acetate, silver sulfate, and silver complex ion salts.

10. The method of claim 9, wherein the concentration of the silver ionic species is between 0.001 M and 12.7 M.

11. The method of claim 4, wherein the molar ratios of silver reducing agent, organic polymer template protective compound and silver ionic species are between 3:1:1 and 200:100:1.

12. The method of claim 1, wherein the halogen ion solution includes, but is not limited to sodium chloride, potassium chloride, sodium bromide, potassium bromide, sodium iodide, potassium iodide, tetrabutyl ammonium chloride, tetrabutylammonium bromide, hexadecyl trimethyl ammonium chloride, hexadecyl trimethyl ammonium bromide.

13. The method of claim 7, wherein the concentration of halogen ion solution is 0.001M-0.65 M.

14. The method of claim 13, wherein the halogen ion solution includes, but is not limited to high-purity water, pure water, distilled water, ultrapure water.

15. The method of claim 8, where the reaction temperature is 100-200° C.

16. The method of claim 8, where the period of time is in the range of 1 hour to 48 hours.

17. A method for forming silver nanowires comprising:
adding a silver reducing agent, an organic polymer template protective compound and a halogen ion solution to highly pure water to obtain solution A;
adding a solution containing a silver ionic species and highly pure water to said solution A to obtain solution B;
incubating and heating solution B for a period of time suitable for the formation of silver nanowires.

18. The method of claim 17 wherein the reducing agent is selected from the group which includes, but is not limited to: polyethylene glycol (PG), glucose, citrate or a combination thereof;
wherein the organic polymer template protective compound includes, but is not limited to, polyacrylonitrile (PAN), polyethylene glycol (PEG), polyoxyethylene (PEO), polyvinyl alcohol (PVA), polyvinylpyrrolidone (PVP), N-methyl pyrrolidone, vinyl pyrrolidone, 2-pyrrolidon, or a combination thereof; and
wherein the highly pure water is selected from the group which includes, but is not limited to: low conductivity water, degassed water, distilled water, ultrapure water or a combination thereof.

19. The method of claim 17, wherein said method further includes the step of adding a prefabricated seed.

20. The method of claim 19, wherein the prefabricated seed is a silver halide particle selected from the group which includes, but is not limited to silver chloride, silver bromide, silver iodide.
